(19) United States
(12) Patent Application Publication
(10) Pub. No.: US 2025/0356605 A1
(43) Pub. Date: Nov. 20, 2025

(54) INTERACTION METHOD, APPARATUS, DEVICE AND STORAGE MEDIUM

(71) Applicant: Beijing Zitiao Network Technology Co., Ltd., Haidian District (CN)

(72) Inventors: Yuxuan Zhao, Beijing (CN); Huimin Jiang, Beijing (CN); Jiangong Mei, Beijing (CN)

(21) Appl. No.: 18/919,296

(22) Filed: Oct. 17, 2024

(30) Foreign Application Priority Data
May 17, 2024 (CN) 202410620346.5

(51) Int. Cl. G06T 19/20

(52) U.S. Cl. CPC G06T 19/20; G06T 2219/2024

(57) ABSTRACT

The embodiment of the invention relates to an interaction method, apparatus, device and a storage medium. The method provided by the invention includes: presenting, in a session interface with a target object, a first virtual object interacted by a current user in cooperation with the target object; in response to a set of interaction events between the current user and the target object satisfying a first predetermined condition, providing to the current user a second virtual object interacted in cooperation with the target object; and switching the session interface to present the second virtual object.

### CROSS REFERENCE

This application claims priority of the Chinese patent application No. 202410620346.5, filed on May 17, 2024, and entitled “INTERACTION METHOD, APPARATUS, DEVICE AND STORAGE MEDIUM”, the entire content of which is incorporated herein by reference.

### FIELD

Example embodiments of the present disclosure generally relate to the field of computers, and in particular, to methods, apparatuses, devices, and computer-readable storage media for interaction.

### BACKGROUND

In recent years, with the rapid development of the Internet, online sessions have become an important way for people to communicate. For example, an instant messaging application or other application capable of providing instant messaging service can provide an online session environment for a user to help people realize convenient exchange of messages.

### SUMMARY

In a first aspect of the present disclosure, an interaction method is provided. The method comprises: presenting, in a session interface with a target object, a first virtual object interacted by a current user in cooperation with the target object; in response to a set of interaction events between the current user and the target object satisfying a first predetermined condition, providing to the current user a second virtual object interacted in cooperation with the target object; and switching the session interface to present the second virtual object.

In a second aspect of the present disclosure, an apparatus for interaction is provided. The device comprises a presentation module, configured to present, in a session interface with a target object, a first virtual object interacted by a current user in cooperation with the target object; a provision module, configured to in response to a set of interaction events between the current user and the target object satisfying a first predetermined condition, provide to the current user a second virtual object interacted in cooperation with the target object; and a switching module, configured to switch the session interface to present the second virtual object.

In a third aspect of the present disclosure, an electronic device is provided. The apparatus includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in connection with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2A to FIG. 2E illustrate example interfaces in accordance with some embodiments of the present disclosure;

FIG. 3 illustrates a flowchart of an example process of interaction according to some embodiments of the present disclosure;

FIG. 4 illustrates a schematic structural block diagram of an example apparatus for interaction according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the headline of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definition may also be included below. The terms “first,” “second,” and the like may refer to different or identical object. Other explicit and implicit definition may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, processed, forwarded, used, etc., all of which are performed on the premise that the user knows and confirms. Accordingly, when implementing the embodiments of the present disclosure, the types, the usage scope, the usage scenario, and the like of the data or information that may be involved should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user's rejection on the processing of personal information other than necessary information required by the basic function, does not affect the basic function used by the user.

As mentioned above, online sessions have become an important way for people to communicate daily. Traditional session interfaces typically only present relevant message in the session, which makes participants of the session difficult to perceive the interaction state. In addition, such a session interface also makes it difficult to promote the interaction between session participants, which affects the efficiency of session interaction to some extent.

The embodiment of the invention provides an interaction scheme. According to the scheme, in a session interface with a target object, a first virtual object interacted by a current user in cooperation with the target object is presented; in response to a set of interaction events between the current user and the target object satisfying a first predetermined condition, provide to the current user a second virtual object interacted in cooperation with the target object; and the session interface is switched to present the second virtual object.

In this way, embodiments of the present disclosure can switch the corporately interacted virtual object presented in the interface according to the interaction event between the session participants. On the one hand, this can better help the session participant better perceive the interaction state between the participants; on the other hand, this can better facilitate the participant to complete the corresponding interaction, thereby improving the interaction experience.

Various example implementations of this scheme are described in detail below in connection with the accompanying drawings.

### Example Environment

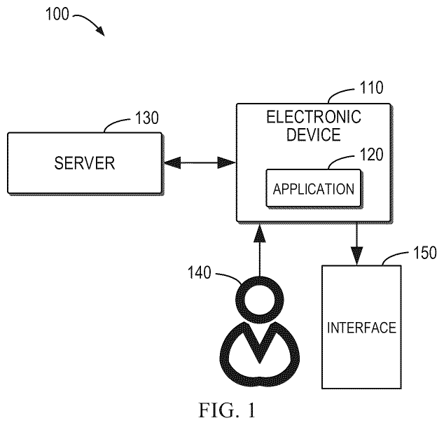

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. Application 120 may be any suitable type of application for interface interaction, examples of which may include, but are not limited to, instant messaging applications, social applications, image applications, or other suitable applications. The user 140 may interact with the application 120 via the electronic device 110 and/or its attached device.

In the environment 100 of FIG. 1, if the application 120 is active, the electronic device 110 may present, via the application 120, an interface 150 for supporting interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scene in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

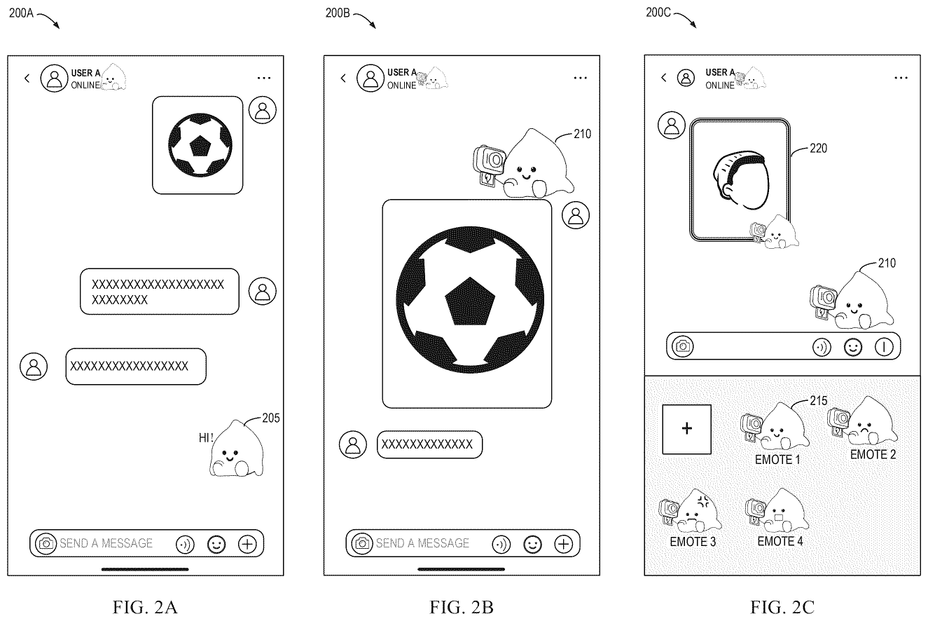

FIG. 2A to FIG. 2E illustrate example interfaces 200A to 200E, in accordance with some embodiments of the present disclosure. The interface 200A to the interface 200E may be provided, for example, by the electronic device 110 shown in FIG. 1.

In some embodiments, the electronic device 110 may present a session interface 200A as shown in FIG. 2A. As an example, such a session interface 200A may be associated with a current user and a target object (e.g., user A).

As shown in FIG. 2A, the electronic device 110 may present the first virtual object 205 in the session interface 200A. Such a first virtual object 205 may be, for example, a virtual object that is acquired based on an interaction operation between the current user and the target object and that interacts in combination.

As an example, such a first virtual object 205 may include a virtual object associated with both the current user and the target object. Additionally, at least one attribute of the first virtual object 205 may be updated accordingly, for example, according to an interaction event between the current user and the target object, so that the first virtual object 205 may have different visual representations and/or different interaction capabilities, for example.

In some embodiments, if a set of interaction events between the current user and the target object satisfies a preset condition, the electronic device 110 may further provide a second virtual object different from the first virtual object 205 to the target user.

In some embodiments, such a set of interaction events may include an interaction event that occurs in a session corresponding to the current user and the target object in the session interface 200A. For example, such interaction events may include text message interaction in a conversation, image message interaction, audio message interaction, video call interaction, voice call interaction, emoji interaction, and the like.

In some embodiments, such a set of interaction events may also include an interaction event that occurs between the current user and the target object independently of the session. For example, such interaction events may include browsing events, like events, collection events, forwarding events, and the like of the work published by the current user with respect to the target object.

In some embodiments, such a set of interaction events may also be associated with a time, for example, such an interaction event may include a number of days that the current user and a target object continuously or collectively sends a preset type of interaction message in the conversation interface for a threshold number of days, etc.

It should be understood that the foregoing obtaining and using of information about the interaction event is performed in a case where the related user is informed and is authorized by the user.

In some embodiments, the first virtual object and the second virtual object may, for example, have different visual images, different interaction capabilities, and/or be associated with different interaction resource/display resources.

In some embodiments, the first virtual object and the second virtual object may be associated with the same virtual entity. For example, the first virtual object and the second virtual object may be associated with the same virtual object entity managed by the platform, but the first virtual object and the second virtual object may correspond to different entity states of the virtual object entity.

Alternatively, the first virtual object and the second virtual object may be associated with different virtual entities. For example, the first virtual object and the second virtual object may be associated with different virtual object entities managed by the platform, such that they have independent attribute information, interaction capabilities, and the like.

Further, as shown in FIG. 2B, the electronic device 110 may further switch the session interface to present the obtained second virtual object 210 to represent that the interaction between the current user and the target object has reached the preset level.

Taking FIG. 2B as an example, as an example, if the current user and the target object have completed sending a predetermined number of message to each other on the same day and completed sending an picture or video to each other on the same day, the target user may be provided with a second virtual object interacted in cooperation with the target object.

In some embodiments, the electronic device 110 may display the second virtual object 210 at a preset position in the session interface 200B, for example. For example, the second virtual object 210 may be displayed at an edge of the session window to reduce occlusion of information displayed within the session window.

In some embodiments, the electronic device 110 may further display the second virtual object 210 in the configured display position based on the configuration operation of the user to match the interaction habit of the user.

In still other embodiments, the electronic device 110 may also present a dynamic effect associated with the second virtual object 210 in association with a message element in the session interface 200B. For example, the second virtual object 210 may present a dynamic effect associated with the message when a predetermined type of message is received or sent in the session interface 200B.

Taking FIG. 2B as an example, when a new picture or video message is sent and/or received in the session interface 200B, the second virtual object 210 may, for example, be moved from the initial display position to the vicinity of the picture or video message to, for example, indicate that the obtaining and/or attribute change of the second virtual object 210 is associated with the interaction of such a message.

For example, the obtaining condition of the second virtual object 210 may be related to a picture or a video message interaction, or the change of the preset attribute of the second virtual object 210 may be related to picture or video message interaction in the session.

In some embodiments, the electronic device 110 may also be associated with a second virtual object 210 to provide a set of interaction resources associated with the second virtual object 210. Taking FIG. 2C as an example, as shown, the electronic device 110 may, for example, provide a set of expressions 215 associated with the second virtual object 210. As an example, such a set of expressions 215 may, for example, have a visual style corresponding to the second virtual object 210.

In some embodiments, such interaction resources may also include any appropriate type of interaction resource in addition to the emote resource, examples of which may include, but are not limited to: a red envelope cover, a virtual gift, a voice expression, a work template, a camera filter, a sticker resource, and the like.

In some embodiments, such a set of interaction resources may be provided to the target user, for example, to support the usage by the target user in any suitable interaction scenario. For example, a user may use such a virtual resource, e.g., expression 215, in a session interface or a comment interface with other interaction object.

In other embodiments, such a set of interaction resources may be configured for use only in a session interface with a target object. That is, the user may be allowed to use such an expression 215 only in the session with the target user, for example.

In still other embodiments, such a set of interaction resources may be configured for use in an interaction scenario between the current user and the target object. For example, such an interaction scenario may include any suitable interaction scenario associated with the current user and the target object, examples of which may include, but are not limited to, a session interface between the current user and the target object, a comment interface of the current user with respect to the work of the target object, an interaction interface of the current user with respect to the live stream room of the target object, and the like.

In this way, the embodiments of the present disclosure can further enrich the interaction manner between the current user and the target object.

In still other embodiments, the electronic device 110 may further adjust the display style of the at least one interface element in the session interface 200C according to the displayed second virtual object 210.

Taking FIG. 2C as an example, the electronic device 110 may, for example, modify the picture or video message 220 in the session interface 200C from the default style to the target style associated with the second virtual object 220. For example, the border of the picture message may include elements related to the second virtual object 220.

In some embodiments, the adjusted interface element may also include, but is not limited to, a session background element, a message bubble element, a text message (e.g., a modified font), or the like.

In some embodiments, types of interface elements triggered by different virtual object may be different. Specifically, the electronic device 110 may further determine, based on the target attribute of the applied second virtual object 210, an element type of at least one interface element to be adjusted in the session interface 200C. In some examples, such target attributes may, for example, be associated with obtaining a first predetermined condition of the second virtual object 210.

For example, the target attribute of the second virtual object 210 may, for example, represent an association between the second virtual object 210 and the picture message and/or the video message. Accordingly, the electronic device 110 may determine, based on the attribute, that the interface element to be adjusted includes a picture message and/or a video message.

As another example, a condition for obtaining another virtual object may include, for example, a number of the text message sent between each other reaching a threshold. Correspondingly, the target attribute of the virtual object may, for example, represent an association between the virtual object and the text message. Accordingly, when the virtual object is applied, the electronic device 110 may determine, based on the attribute, that the interface element to be adjusted includes a text message.

In this way, the embodiments of the present disclosure can provide a more uniform interface style by adjusting the display style of the interface element, thereby facilitating the user to perceive the corresponding interaction state more clearly.

In some embodiments, switching the session interface to present the second virtual object 210 described above may be performed automatically after the current user obtains the second virtual object 210. Alternatively or additionally, switching the session interface to present the second virtual object 210 described above may also be performed in response to receiving a preset operation of the user.

Specifically, as shown in FIG. 2D, after the user obtains the second virtual object 210, the electronic device 110 may display the interface 200D shown in FIG. 2D. Such an interface 200D may be a viewing interface of the second virtual object 210.

Accordingly, the electronic device 110 may display the switching portal 225 associated with the second virtual object 210 in the interface 200D. Further, upon receiving the selection of the switching portal 225, the electronic device 110 may accordingly switch the session interface with the target object to display the second virtual object 210.

In some embodiments, the electronic device 110 may further support performing, through the interface 200D, ceasing to set the second virtual object 210 as the default image, hiding the virtual object in the session interface, modifying the nickname of the second virtual object 210, deleting the virtual object interacted in cooperation between the target object and the current user, and the like.

In some embodiments, the electronic device 110 may also display the description information associated with the second virtual object 210 in the interface 200D, for example. Such description information may include, but is not limited to, a condition of obtaining the second virtual object 210, an interaction operation 235 related to the second virtual object 210, an valid time period of the second virtual object 210 (for example, valid for today), a progression information 230 for permanently obtaining the second virtual object 210, and the like.

In some embodiments, the second virtual object 210 obtained by the user may be associated with, for example, the first time period. For example, as shown in FIG. 2D, the second virtual object 210 may be valid for the current day.

In some embodiments, the electronic device 110 may further determine whether a new condition is satisfied according to a second set of interaction events between the current user and the target object. In some embodiments, such a new condition is different from the condition of obtaining the second virtual object 210 associated with the second period.

As an example, if the second set of interaction events does not satisfy the new condition, in response to the expiration of the first period, the electronic device 110 may set the second virtual object 210 to the invalid state, and may stop presenting the second virtual object 210 in the session interface accordingly.

In some embodiments, when the second virtual object 210 is in the invalid state, the electronic device 110 may also change the display style of the second virtual object 210 in the associated page accordingly. As an example, such an association page may include, for example, a viewing interface 200D or other suitable interface of the second virtual object 210.

For example, the electronic device 110 may, for example, adjust an image feature such as a color (for example, change to gray gray) of the second virtual object 210 to indicate that the second virtual object 210 is in a invalid state, and can activate the second virtual object 210 only after a new condition is satisfied.

Conversely, if the second set of interaction events satisfies the new condition, the electronic device 110 may provide the second virtual object 210 associated with the second period to the user. Such a second period may be longer than the first period. As an example, such a second virtual object 210 may be in a permanently valid state.

In some embodiments, the electronic device 110 may further support a user viewing other obtained virtual objects or to-be-obtained virtual object. As an example, the electronic device 110 may present the interface 200E as shown in FIG. 2E, for example, in response to a preset operation (for example, a sliding operation or a click on a switching button) received in the interface 200D.

As an example, the interface 200E may correspond to a viewing interface of the third virtual object 240. Such a third virtual object 240 may be, for example, a virtual object interacted in cooperation with the target object obtained by the current user. In some embodiments, the condition for obtaining the third virtual object 240 may be different from the condition for obtaining the second virtual object 210, for example.

Similarly, the electronic device 110 may provide a switching portal 245 associated with the third virtual object 240 and may switch the session interface with the target object to display the third virtual object 240 based on the selection of the switching portal 240.

Based on this manner, the embodiments of the present disclosure may support the user to manage the obtained virtual object more conveniently, and may correspondingly configure the virtual object to be displayed in the session interface, thereby improving the flexibility of interaction.

In some embodiments, for a virtual object that has not been obtained by the user, the electronic device 110 may, for example, present a preset visual image in a corresponding viewing interface instead of presenting a visual image corresponding to the virtual object. Further, after the virtual object is obtained, the electronic device 110 may, for example, update the viewing interface to display a visual image corresponding to the virtual object.

Based on the process described above, the embodiments of the present disclosure can switch the corporately interacted virtual object presented in the interface according to the interaction event between the session participants. On the one hand, this can better help the session participant better perceive the interaction state between the participants; on the other hand, this can better facilitate the participant to complete the corresponding interaction, thereby improving the interaction experience.

It should be understood that the appearance, type, number and the like of the specific virtual object mentioned above are all intended as examples, and do not constitute a limitation on the present disclosure.

### Example Processes

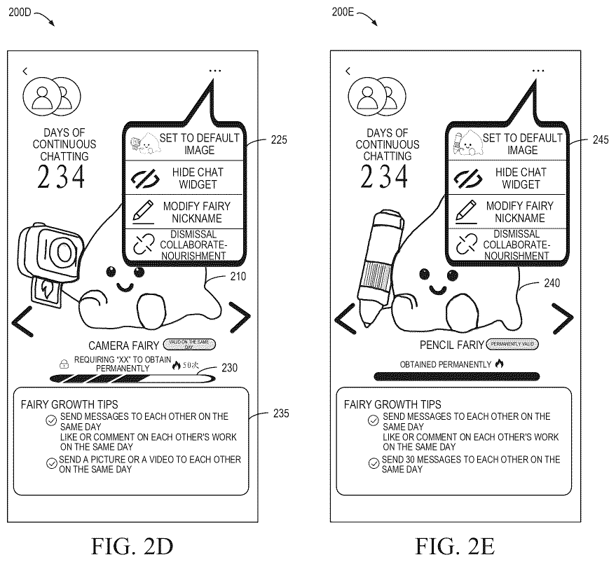

FIG. 3 illustrates a flowchart of an example process 300 of interaction in accordance with some embodiments of the present disclosure. Process 300 may be implemented at electronic device 110. The process 300 is described below with reference to FIG. 1.

As shown in FIG. 3, at block 310, the electronic device 110 may present, in a session interface with a target object, a first virtual object interacted by a current user in cooperation with the target object.

At block 320, the electronic device 110 may in response to a set of interaction events between the current user and the target object satisfying a first predetermined condition, provide to the current user a second virtual object interacted in cooperation with the target object.

At block 330, the electronic device 110 may switch the session interface to present the second virtual object.

In some embodiments, switching the session interface to present the second virtual object comprises: presenting a first viewing interface associated with the second virtual object; presenting a first switching portal associated with the second virtual object in the first viewing interface; and in response to a selection of the first switching portal, switching the session interface to present the second virtual object.

In some embodiments, the process 300 further includes: in response to a predetermined operation in the first viewing interface, presenting a second viewing interface associated with a third virtual object, wherein the third virtual object is provided to the target user in response to a second predetermined condition being satisfied.

In some embodiments, the process 300 further includes: presenting a second switching portal associated with the third virtual object in the second viewing interface; and in response to a selection of the second switching portal, switching the session interface to present the third virtual object.

In some embodiments, providing to the current user a second virtual object interacted in cooperation with the target object comprises: determining that the first predetermined condition is satisfied based on the set of interaction events between the current user and the target object; and providing the second virtual object associated with a first time period to the target user.

In some embodiments, the set of interaction events comprise a first set of interaction events, and the process 300 further includes: in response to a second set of interaction events between the current user and the target object failing to satisfy a third predetermined condition, ceasing presenting the second virtual object in the session interface after the first time period expires; or in response to the second set of interaction events between the current user and the target object satisfying the third predetermined condition, providing the second virtual object associated with a second time period to the target user, the second time period being greater than the first time period.

In some embodiments, the process 300 further includes: in response to the second set of interaction events failing to satisfy the third predetermined condition, changing a display style of the second virtual object in an associated page.

In some embodiments, the process 300 further includes providing a set of interaction resources associated with the second virtual object to the current user.

In some embodiments, the set of interaction resources are configured to be used in the session interface with the target object; or the set of interaction resources are configured to be used in an interaction scenario between the current user and the target object, the interaction scenario comprising the session interface.

In some embodiments, the process 300 further includes adjusting at least one interface element in the session interface to a display style associated with the first virtual object.

In some embodiments, the process 300 further includes: determining, based on a target attribute of the second virtual object, an element type of the at least one interface element to be adjusted in the session interface, wherein the target attribute is associated with the first predetermined condition.

### Example Apparatus and Apparatus

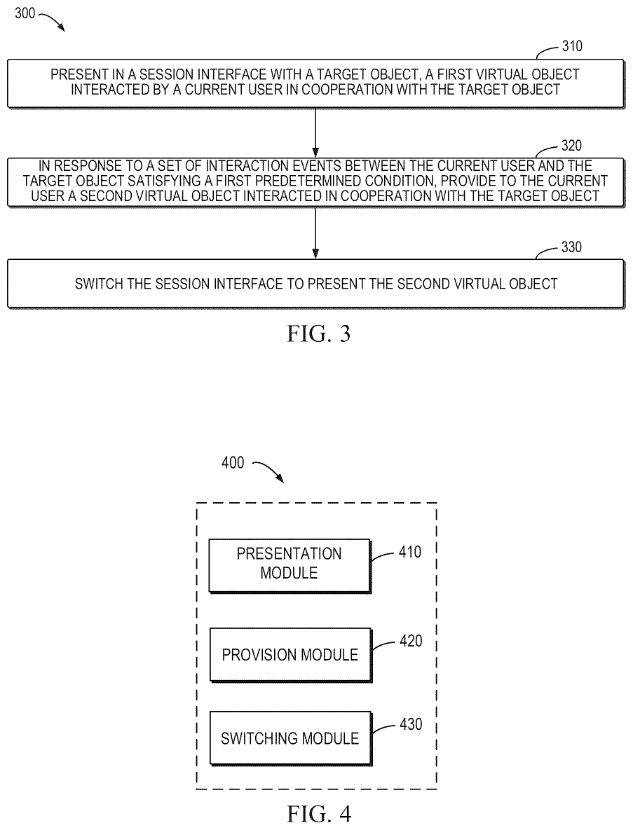

Embodiments of the present disclosure also provide a corresponding apparatus for implementing the above method or process. FIG. 4 shows a schematic structural block diagram of an example apparatus 400 for interaction according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes a presentation module 410, configured to present, in a session interface with a target object, a first virtual object interacted by a current user in cooperation with the target object; a provision module 420, configured to in response to a set of interaction events between the current user and the target object satisfying a first predetermined condition, provide to the current user a second virtual object interacted in cooperation with the target object; and a switching module 430, configured to switch the session interface to present the second virtual object.

In some embodiments, switching the session interface to present the second virtual object comprises: presenting a first viewing interface associated with the second virtual object; presenting a first switching portal associated with the second virtual object in the first viewing interface; and in response to a selection of the first switching portal, switching the session interface to present the second virtual object.

In some embodiments, the presentation module 410 is further configured to: in response to a predetermined operation in the first viewing interface, present a second viewing interface associated with a third virtual object, wherein the third virtual object is provided to the target user in response to a second predetermined condition being satisfied.

In some embodiments, the presentation module 410 is further configured to: present a second switching portal associated with the third virtual object in the second viewing interface; and in response to a selection of the second switching portal, switch the session interface to present the third virtual object.

In some embodiments, the provision module 420 is further configured to: determine that the first predetermined condition is satisfied based on the set of interaction events between the current user and the target object; and provide the second virtual object associated with a first time period to the target user.

In some embodiments, the set of interaction events comprise a first set of interaction events, and the apparatus 400 further includes an updating module, configured to: in response to a second set of interaction events between the current user and the target object failing to satisfy a third predetermined condition, ceasing presenting the second virtual object in the session interface after the first time period expires; or in response to the second set of interaction events between the current user and the target object satisfying the third predetermined condition, providing the second virtual object associated with a second time period to the target user, the second time period being greater than the first time period.

In some embodiments, the presentation module 410 is further configured to: in response to the second set of interaction events failing to satisfy the third predetermined condition, change a display style of the second virtual object in an associated page.

In some embodiments, the provision module 420 is further configured to: provide a set of interaction resources associated with the second virtual object to the current user.

In some embodiments, the set of interaction resources are configured to be used in the session interface with the target object; or the set of interaction resources are configured to be used in an interaction scenario between the current user and the target object, the interaction scenario comprising the session interface.

In some embodiments, the switching module 430 is further configured to adjust at least one interface element in the session interface to a display style associated with the first virtual object.

In some embodiments, the presentation module 410 is further configured to: determine, based on a target attribute of the second virtual object, an element type of the at least one interface element to be adjusted in the session interface, wherein the target attribute is associated with the first predetermined condition.

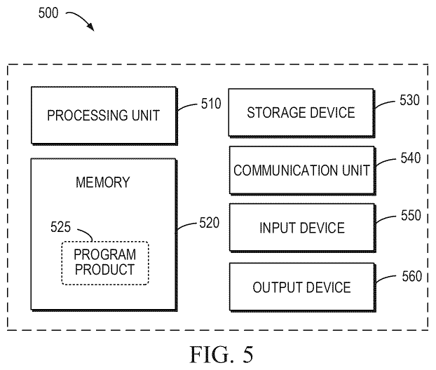

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 730, one or more communication units 540, one or more input devices 550, and one or more output devices 560. The processing unit 510 may be an actual or virtual processor and capable of performing various processes according to program stored in the memory 520. In multiprocessor system, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 520 may include a computer program product 525 having one or more program module modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network Node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instruction.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instruction may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instruction may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. An interaction method comprising:
presenting, in a session interface with a target object, a first virtual object interacted by a current user in cooperation with the target object;
in response to a set of interaction events between the current user and the target object satisfying a first predetermined condition, providing to the current user a second virtual object interacted in cooperation with the target object; and
switching the session interface to present the second virtual object.

2. The method of claim 1, wherein switching the session interface to present the second virtual object comprises:
presenting a first viewing interface associated with the second virtual object;
presenting a first switching portal associated with the second virtual object in the first viewing interface; and
in response to a selection of the first switching portal, switching the session interface to present the second virtual object.

3. The method of claim 2, further comprising:
in response to a predetermined operation in the first viewing interface, presenting a second viewing interface associated with a third virtual object, wherein the third virtual object is provided to the target user in response to a second predetermined condition being satisfied.

4. The method of claim 3, further comprising:
presenting a second switching portal associated with the third virtual object in the second viewing interface; and
in response to a selection of the second switching portal, switching the session interface to present the third virtual object.

5. The method of claim 1, wherein providing to the current user a second virtual object interacted in cooperation with the target object comprises:
determining that the first predetermined condition is satisfied based on the set of interaction events between the current user and the target object; and
providing the second virtual object associated with a first time period to the target user.

6. The method of claim 5, wherein the set of interaction events comprise a first set of interaction events, and the method further comprises:
in response to a second set of interaction events between the current user and the target object failing to satisfy a third predetermined condition, ceasing presenting the second virtual object in the session interface after the first time period expires; or
in response to the second set of interaction events between the current user and the target object satisfying the third predetermined condition, providing the second virtual object associated with a second time period to the target user, the second time period being greater than the first time period.

7. The method of claim 6, further comprising:
in response to the second set of interaction events failing to satisfy the third predetermined condition, changing a display style of the second virtual object in an associated page.

8. The method of claim 1, further comprising:
providing a set of interaction resources associated with the second virtual object to the current user.

9. The method of claim 8, wherein the set of interaction resources are configured to be used in the session interface with the target object; or
the set of interaction resources are configured to be used in an interaction scenario between the current user and the target object, the interaction scenario comprising the session interface.

10. The method of claim 1, further comprising:
adjusting at least one interface element in the session interface to a display style associated with the first virtual object.

11. The method of claim 10, further comprising:
determining, based on a target attribute of the second virtual object, an element type of the at least one interface element to be adjusted in the session interface, wherein the target attribute is associated with the first predetermined condition.

12. An electronic device comprising:
at least one processing unit; and
at least one memory coupled to the at least one processing unit and storing instructions for execution by the at least one processing unit, the instructions, when executed by the at least one processing unit, causing the electronic device to perform an interaction method comprising:
presenting, in a session interface with a target object, a first virtual object interacted by a current user in cooperation with the target object;
in response to a set of interaction events between the current user and the target object satisfying a first predetermined condition, providing to the current user a second virtual object interacted in cooperation with the target object; and
switching the session interface to present the second virtual object.

13. The device of claim 12, wherein switching the session interface to present the second virtual object comprises:
presenting a first viewing interface associated with the second virtual object;
presenting a first switching portal associated with the second virtual object in the first viewing interface; and
in response to a selection of the first switching portal, switching the session interface to present the second virtual object.

14. The device of claim 13, wherein the method further comprises:
in response to a predetermined operation in the first viewing interface, presenting a second viewing interface associated with a third virtual object, wherein the third virtual object is provided to the target user in response to a second predetermined condition being satisfied.

15. The device of claim 14, wherein the method further comprises:
presenting a second switching portal associated with the third virtual object in the second viewing interface; and
in response to a selection of the second switching portal, switching the session interface to present the third virtual object.

16. The device of claim 12, wherein providing to the current user a second virtual object interacted in cooperation with the target object comprises:
determining that the first predetermined condition is satisfied based on the set of interaction events between the current user and the target object; and
providing the second virtual object associated with a first time period to the target user.

17. The device of claim 16, wherein the set of interaction events comprise a first set of interaction events, and the method further comprises:
in response to a second set of interaction events between the current user and the target object failing to satisfy a third predetermined condition, ceasing presenting the second virtual object in the session interface after the first time period expires; or
in response to the second set of interaction events between the current user and the target object satisfying the third predetermined condition, providing the second virtual object associated with a second time period to the target user, the second time period being greater than the first time period.

18. The device of claim 17, wherein the method further comprises:
in response to the second set of interaction events failing to satisfy the third predetermined condition, changing a display style of the second virtual object in an associated page.

19. The device of claim 12, wherein the method further comprises:
providing a set of interaction resources associated with the second virtual object to the current user.

20. A computer-readable storage medium having a computer program stored thereon, the computer program being executable by a processor to implement an interaction method comprising:
presenting, in a session interface with a target object, a first virtual object interacted by a current user in cooperation with the target object;
in response to a set of interaction events between the current user and the target object satisfying a first predetermined condition, providing to the current user a second virtual object interacted in cooperation with the target object; and
switching the session interface to present the second virtual object.
